(19) United States
(12) Patent Application Publication
(10) Pub. No.: US 2015/0031283 A1
(43) Pub. Date: Jan. 29, 2015

(54) System for Blocking Mobile Cellular Activity within A Transportation Vehicle

(71) Applicants: Michael Francis Francesco, North Bergen, NJ (US); Joseph Michael Ardolino, Cliffside Park, NJ (US)

(72) Inventors: Michael Francis Francesco, North Bergen, NJ (US); Joseph Michael Ardolino, Cliffside Park, NJ (US)

(21) Appl. No.: 14/260,317

(22) Filed: Apr. 24, 2014

Related U.S. Application Data
(60) Provisional application No. 61/858,473, filed on Jul. 25, 2013.

(51) Int. Cl. H04K 3/00

(52) U.S. Cl. CPC H04K 3/415
USPC 455/1

(57) ABSTRACT

A system and method of blocking mobile cellular activity within a transportation vehicle utilizes mobile phone jamming technology in conjunction with at least one sensor to block wireless capability of mobile devices while the transportation vehicle is in motion or capable of motion.

The current application claims a priority to the U.S. Provisional Patent application Ser. No. 61/858,473 filed on Jul. 25, 2013.

### FIELD OF THE INVENTION

The present invention relates generally to transportation vehicles and disabling mobile phones and other portable wireless electronic devices. More particularly, the present invention relates to a system for disabling the use of mobile phones and other portable wireless electronic devices while a transportation vehicle is in motion.

### BACKGROUND OF THE INVENTION

A growing problem within today's society is accidents which relate to the use of a mobile device while driving. Texting, calling, and use of the mobile device's internet while driving has become so commonplace for individuals that many individuals have a hard time distinguishing when an appropriate time is to use these devices. One such time that is highly inappropriate and dangerous is when a vehicle is in motion. The use of a mobile device leads to a significant number of accidents, ranging from minor vehicle damage to unfortunate fatalities. Various states have laws in place prohibiting the use of mobile devices when in a transportation vehicle, though this has not significantly curbed accidents related to use of mobile devices. It is therefore an object of the present invention to provide a device within the vehicle which automatically disables the mobile device or any electronic device not associated with the operation of the vehicle once the vehicle is in motion.

### BRIEF DESCRIPTION OF THE DRAWINGS

FIG. 1 is a schematic diagram showing the electrical connections of the system of the present invention.

FIG. 2 is a side view showing the present invention in use in a transportation vehicle.

FIG. 3 is a stepwise flow diagram describing the method of the present invention.

FIG. 4 is a stepwise flow diagram describing conditions for operating the present invention.

FIG. 5 is a stepwise flow diagram describing conditions for operating the present invention.

FIG. 6 is a stepwise flow diagram describing conditions for operating the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a system and method for disabling use of mobile phones or other electronic mobile devices within a transportation vehicle while the transportation vehicle is in motion or is capable of motion. In the preferred embodiment of the present invention, the present invention functions to disable a mobile device's ability to send text messages, make phone calls, or make use of internet or other wireless network capability when the transportation vehicle is in motion or capable of motion. The present invention may also disable any dashboard computer system within the transportation vehicle and other wireless communications technology such as Bluetooth. The present invention may be integrated into the transportation vehicle during manufacture, or the present invention may be installed into an existing vehicle in an aftermarket or other add-on capacity.

The primary purpose of the present invention is to prevent the driver or operator of the transportation vehicle from being distracted by operating a mobile device while operating the transportation vehicle. For the purposes of the present invention, “mobile device” is used herein to refer to portable electronic devices such as, but not limited to, cell phones, tablet computers, or other portable electronic devices with wireless communication capabilities. In addition, “transportation vehicle” is used herein to refer to any vehicle used for transportation such as, but not limited to, automobiles, buses, trucks, boats, or trains. The present invention does not require registration of individual mobile devices or communicating with cell towers, and blocks all mobile devices within range based on detected motion or capability of motion of the transportation vehicle. The present invention utilizes known radio frequency jamming technology and/or transmits a universal digital cell code(s) to interfere with any wireless communications attempted by the mobile device.

The operator of a transportation vehicle should be focused on the correct and safe operation of the transportation vehicle at all times when active control is required and/or when it is possible for an unsafe situation to be encountered by the transportation vehicle. The scope of situations where neither of these is the case is, in general, when the transportation vehicle is stationary and when the transportation vehicle is in a configuration that does not permit the transportation vehicle to begin motion, as is the case when an automobile is stationary with the gearshift in the parking gear. An automobile that is stationary but in a neutral gear is capable of motion due to gravity, wind or another force. Therefore, the present invention is intended to disable use of mobile devices by the operator while the transportation vehicle is in motion and/or the transportation vehicle is capable of motion. Detecting either motion or the capability of motion can each accomplish the purpose of the present invention individually, but combining the two is a more robust solution.

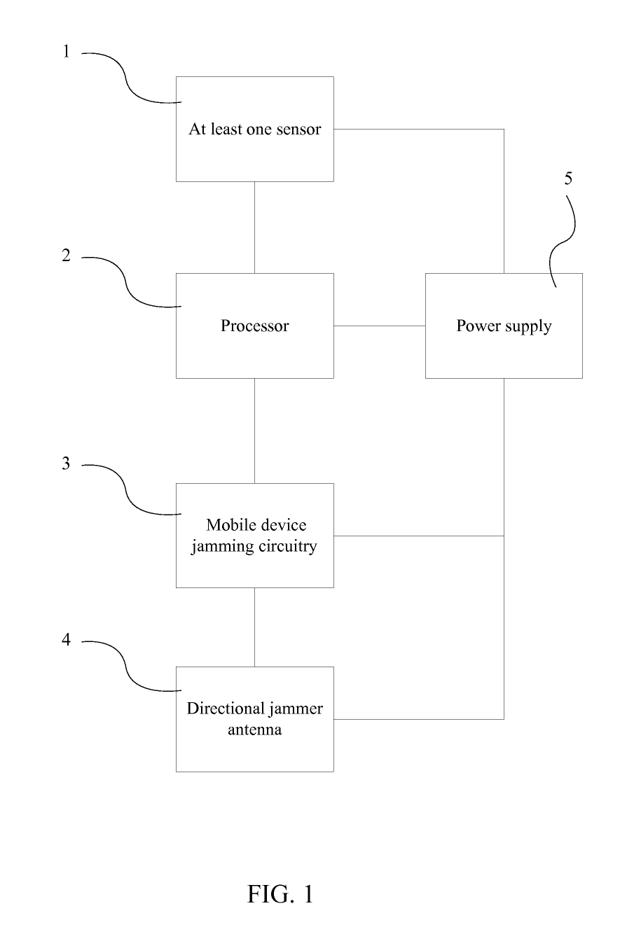

Referring to FIG. 1, the preferred embodiment of the system present invention generally comprises at least one sensor 1, a processor 2, mobile device jamming circuitry 3 and a power supply 5. The at least one sensor 1 is operatively integrated within the transportation vehicle. The at least one sensor 1 functions to detect whether the transportation vehicle is either in motion or is capable of motion. The at least one sensor 1 is positioned within the transportation vehicle in whatever location is appropriate for the function of the at least one sensor 1. In a first preferred embodiment of the present invention, the at least one sensor 1 comprises a motion sensor 1 that detects whether the transportation vehicle is in motion. In this case, the at least one sensor 1 may be any sensor 1 that can receive input that can be interpreted by the processor 2 in order to ascertain the speed of the vehicle. However, most vehicles already have a vehicle speed sensor 1, which can be utilized by the present invention as the at least one sensor 1. Alternatively, the motion sensor 1 may be installed in an existing vehicle separately from the existing vehicle speed sensor 1.

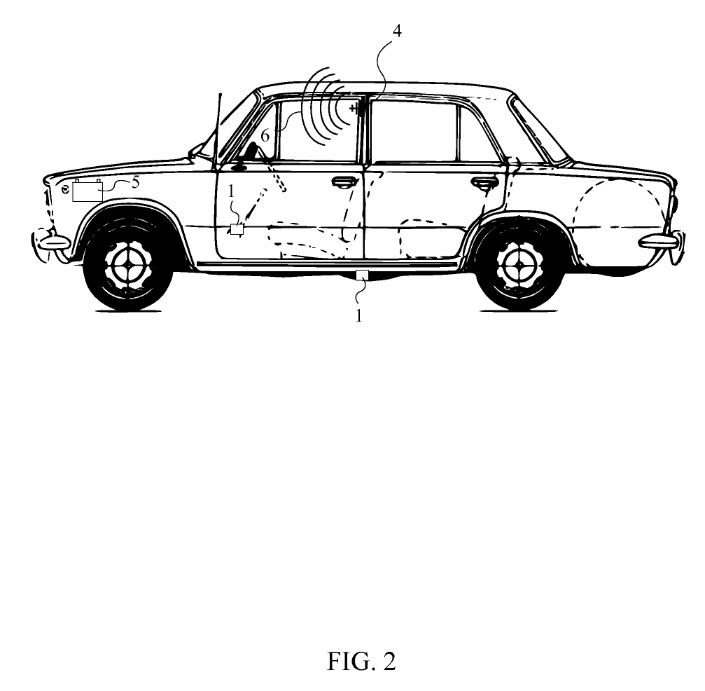

In the first preferred embodiment, the at least one sensor 1 further comprises a gear position sensor 1. The gear position sensor 1 indicates a current gear position for the transportation vehicle. Similar to the motion sensor 1, the gear position sensor 1 may be a preexisting gear position sensor 1 in the transportation vehicle or the gear position sensor 1 may be a separate component added to the transportation vehicle in order to install the present invention. In a transportation vehicle with an automatic transmission, when the gear position sensor 1 indicates that the gearshift is in any position other than the parking gear, wireless communication for the mobile device is disabled by the directional jammer antenna 4. In a transportation vehicle with a manual transmission, a gear position sensor 1 alone is not sufficient to fully determine whether the transportation vehicle is in motion or capable of motion, since there is no parking gear. With a manual transmission, use of a gear position sensor 1 should ideally be coupled with the use of a motion sensor 1 and a parking brake sensor 1, wherein the parking brake sensor 1 detects if the parking brake is engaged. If the gear position sensor 1 indicates a neutral gear, the parking brake sensor 1 indicates that the parking brake is engaged and/or the motion sensor 1 indicates the vehicle is not in motion, use of wireless capability on mobile devices is not blocked. The use of a gear position sensor 1 as well as a vehicle speed sensor 1 is depicted in FIG. 2.

The at least one sensor 1 may further comprise other appropriate sensors 1, such as, but not limited to, a driver sensor 1, wherein the driver sensor 1 detects whether the driver seat of the transportation vehicle is occupied. For example, the driver sensor 1 is a weight sensor 1 under the driver's seat calibrated to detect the weight of a person sitting in the driver's seat. In a second embodiment, the at least one sensor 1 comprises only the motion sensor 1. In a third embodiment, the at least one sensor 1 comprises on the gear position sensor 1. However it should be understood that a plurality of sensors 1 is more desirable since more information being collected allows a more robust interpretation of the state of the transportation vehicle in regards to the purpose of the present invention. In an alternative embodiment, the at least one sensor 1 involves the use of the transportation vehicle's motion sensor device or a global positioning system (GPS) to determine that the transportation vehicle is in motion, capable of motion, in park and/or whether or not the emergency brake is engaged. The GPS capable device may be the only means to ascertain the speed of the transportation vehicle, or the GPS capable device may be utilized in conjunction with one or a combination of the aforementioned sensors 1.

The processor 2 of the present invention is a component or combination of components of the electronic variety such as, but not limited to, circuit boards, wires, computers, or processor necessary to facilitate the translation of electrical input signals into desired effects in the operation of the system. The processor 2 of the present invention may refer to an existing processor 2 installed during the manufacture of the transportation vehicle, or the processor 2 may be a separate unit installed specifically to facilitate the present invention. The processor 2 is positioned within the transportation vehicle. The processor 2 is electronically connected to the at least one sensor 1 and the mobile device jamming circuitry 3, wherein the processor 2 uses the mobile device jamming circuitry 3 to cause the directional jammer antenna 4 to broadcast short-range cellular jamming radio waves 6 if the at least one sensor 1 detects the transportation vehicle is in motion or is capable of motion. The processor 2 is the component of the present invention that carries out the method described later in order to implement the present invention.

The mobile device jamming circuitry 3 is a component or combination of components of the electronic variety known to mobile phone or mobile device jamming hardware such as, but not limited to, a voltage-controlled oscillator, a tuning circuit, a noise generator, and a radio frequency amplifier. The mobile device jamming circuitry 3 is electrically connected to the directional jammer antenna 4, so that cellular jamming frequencies produced by the mobile device jamming circuitry 3 are transmitted to and broadcast by the directional jammer antenna 4. The mobile device jamming circuitry 3 is positioned within the transportation vehicle in any appropriate location behind the driver and front passenger seats with the antenna directed forward.

As previously mentioned the directional jammer antenna 4 is electronically connected to the mobile device jamming circuitry 3 as in currently known cellular jamming technology, and broadcasts short-range cellular jamming radio waves 6. The mobile device jamming circuitry 3 and the directional jammer antenna 4 should be configured so that the short-range cellular jamming radio waves 6 do not traverse more physical distance than necessary to disrupt wireless communications inside the transportation vehicle, such as, but not limited to 15 to 20 feet or less; the present invention should not affect any adjacent or nearby transportation vehicle or mobile device users. The short-range cellular jamming radio waves 6 can be configured to block any and all cellular phone network frequencies available for public use, such as, but not limited to, the AMPS standard, the TACS standard, the GSM standard, the CDMA standard, the D-AMPS or TDMA standard, or any other relevant cellular network frequencies or standards. The short-range cellular jamming radio waves 6 should not be able to interfere with frequencies used by police, military, government, emergency services, airports, or other similar entities. In addition, the radio waves produced by the directional jammer antenna 4 should be in compliance with all Federal Communications Commission (FCC) regulations.

Cellular jamming technology requires an antenna to broadcast cellular jamming radio waves, but does not necessarily require the antenna to be directional. The present invention utilizes a directional jammer antenna 4 because the intent of the present invention is solely to eliminate the use of mobile devices by the driver or operator and also by any front seat passengers, if any are positioned in a front seat or other forward location to the driver or operator of the transportation vehicle. Passengers or other occupants of the transportation vehicle should still be able to use the wireless communication functions of their mobile devices while the transportation vehicle is in motion. To this end, in the preferred embodiment of the present invention the directional jammer antenna 4 is positioned within the interior of the transportation vehicle and is oriented towards the front end of the transportation vehicle.

More particularly, the directional jammer antenna 4 is positioned rearward of and oriented toward a driver seat of the transportation vehicle, and broadcasts the short-range cellular jamming radio waves 6 in an obtuse arc toward the front end of the transportation vehicle. The directional jammer antenna 4 should be positioned forward within the transportation vehicle of passengers rearward the driver's seat, in order to block the driver's use of the mobile device without blocking the passengers' use of mobile devices. The directional jammer antenna 4 may take the form of a radio telescope, a parabolic antenna, or any type of antenna or radio wave broadcasting system that fulfills the aforementioned function. In one embodiment, the directional jammer is contained within an internal lighting fixture common to many transportation vehicles, or in a separate enclosure attached to the ceiling of the transportation vehicle or in another appropriate location within the transportation vehicle.

The power supply 5 may be any source of sufficient electrical power to enable the use of the components of the present invention. The power supply 5 may be a battery already utilized in the operation of the transportation vehicle, a separate battery installed specifically for the use of the present invention, or another type of power source. The power supply 5 is electrically connected to and provides power to the at least one sensor 1, the processor 2, the mobile device jamming circuitry 3, and the jamming antenna.

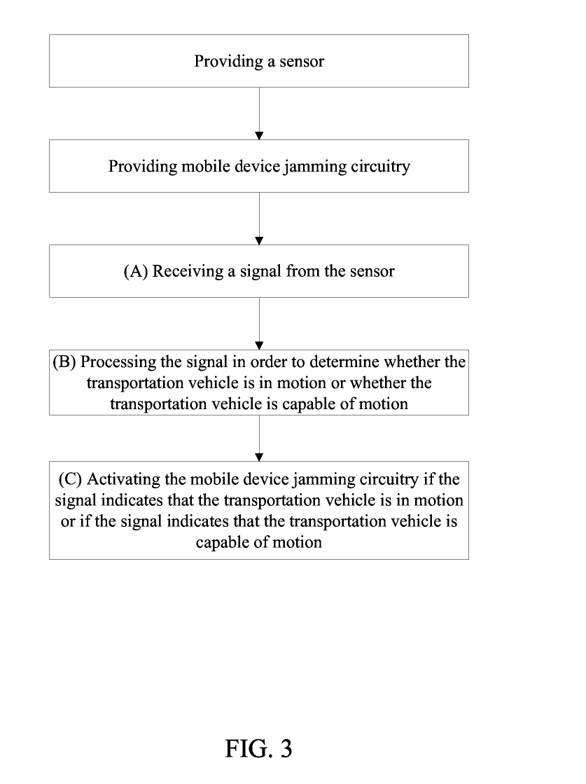

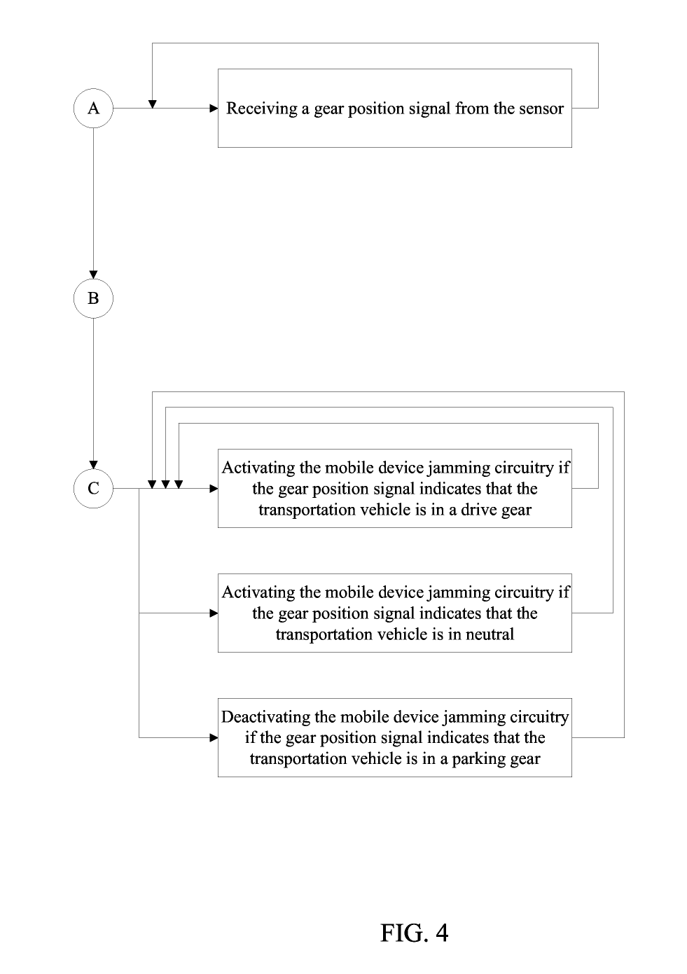

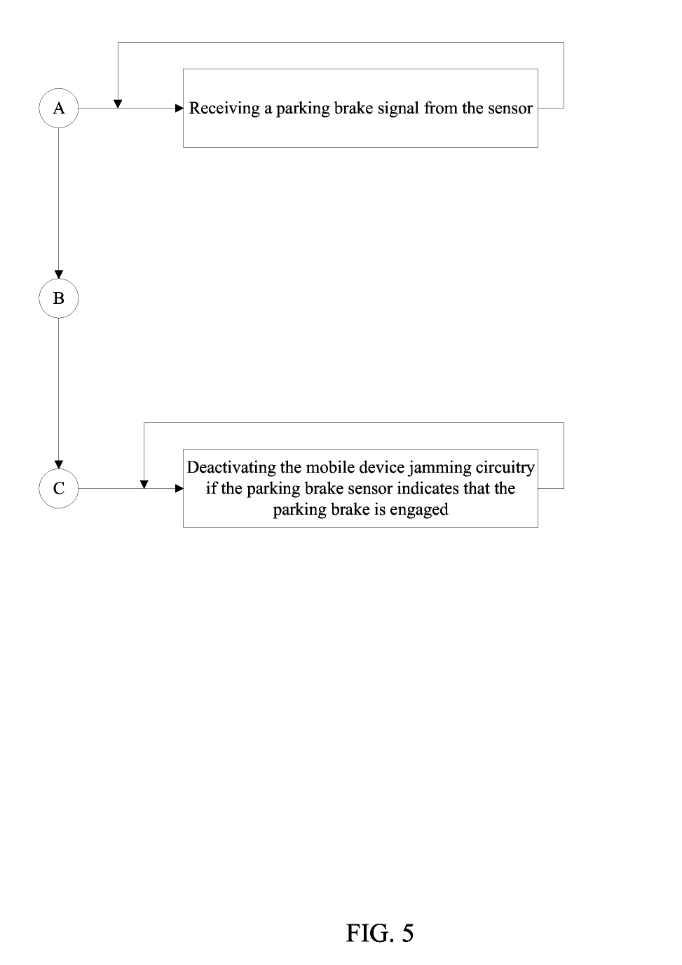

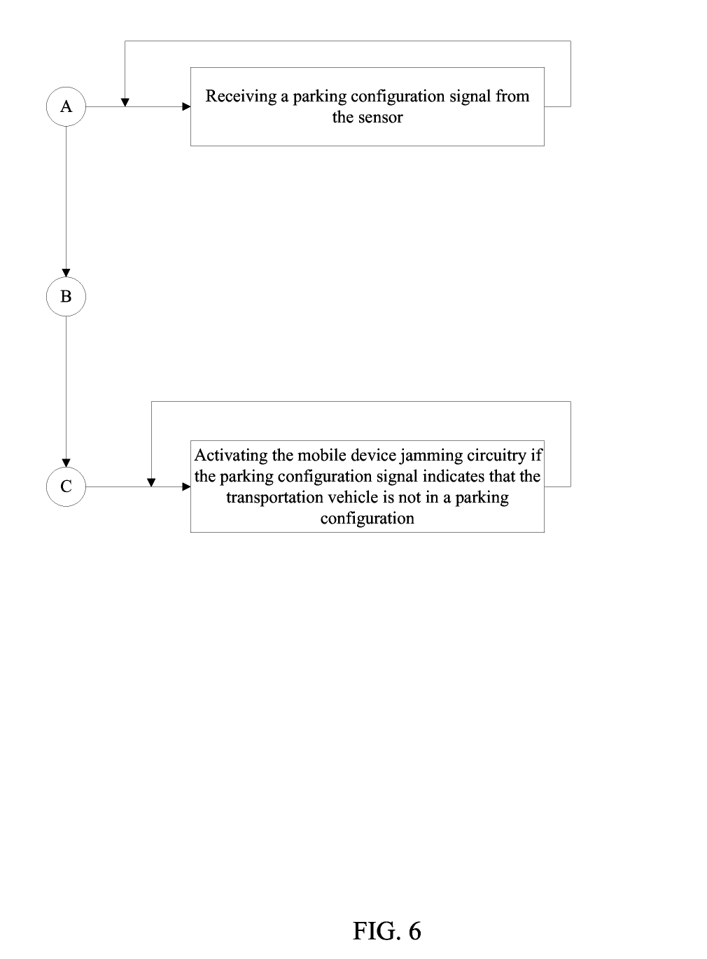

The method of utilizing the system of the present invention is as follows, as shown in FIGS. 3-6. A sensor 1 is provided as well as mobile device jamming circuitry 3. The sensor 1 is operatively integrated within the transportation vehicle. The mobile device jamming circuitry 3 is electrically connected to the directional jammer antenna 4 which is positioned within the interior of the transportation vehicle. A signal is received from the sensor 1. The signal is processed in order to determine whether the transportation vehicle is in motion or whether the transportation vehicle is capable of motion. The mobile device jamming circuitry 3 is activated if the signal indicates that the transportation vehicle is in motion or is the signal indicated that the transportation vehicle is capable of motion, wherein the mobile device jamming circuitry 3 causes the directional jamming antenna to broadcast short-range cellular jamming radio waves 6 if the mobile device jamming circuitry 3 is activated.

In one preferred embodiment, the sensor 1 is a gear position sensor 1, and the signal received from the sensor 1 is a gear position signal received from the gear position sensor 1. If the gear position signal indicates that the transportation vehicle is in a parking gear, the mobile device jamming circuitry 3 is deactivated. If the gear position signal indicates that the transportation vehicle is in a drive gear, the mobile device jamming circuitry 3 is activated. If a parking brake sensor 1 is utilized, the mobile device jamming circuitry 3 is deactivated if the gear position signal indicates that the transportation vehicle is in a parking gear and if a parking brake status signal is received from the parking brake sensor 1 indicating that the parking brake is engaged. In general, a parking configuration signal is received from one or more sensors 1, and the mobile device jamming circuitry 3 is activated if the parking configuration signal indicates that the transportation vehicle is not in a parking configuration. In the parking configuration, the transportation vehicle is not in motion, and not capable of motion such as being in a drive gear or a neutral gear. It should be noted that the present invention is not limited to detecting both motion of the transportation vehicle and capability of motion of the transportation vehicle. Alternate embodiments may solely utilize either motion of the transportation vehicle or capability of motion of the transportation vehicle.

Additionally, jamming frequencies and possible digital universal codes may be utilized in the circuitry of cell phones or other devices that recognize pass off/roaming or no service codes, or other codes that can be blocked or jammed to inhibit texting, talking on the phone, or other internet uses.

Although the invention has been explained in relation to its preferred embodiment, it is to be understood that many other possible modifications and variations can be made without departing from the spirit and scope of the invention as hereinafter claimed.

What is claimed is:

1. A system for blocking mobile cellular activity within a transportation vehicle comprises:
at least one sensor;
a processor;
mobile device jamming circuitry;
a directional jammer antenna, wherein the directional jammer antenna broadcasts short-range cellular jamming radio waves and/or digital cell phone codes, therefore blocking cellular service;
a power supply;
the directional jammer antenna being positioned within the interior of the transportation vehicle;
the directional jammer antenna being oriented toward the front end of the transportation vehicle;
the at least one sensor being operatively integrated within the transportation vehicle; and
the processor being electronically connected to the at least one sensor, the power supply the mobile device jamming circuitry, wherein the processor uses the mobile device jamming circuitry to cause the directional jammer antenna to broadcast short-range cellular jamming radio waves if the at least one sensor detects the transportation vehicle is in motion or is capable of motion.

2. The system for blocking mobile cellular activity within a transportation vehicle as claimed in claim 1 comprises:
the mobile device jamming circuitry being electrically connected to the directional jammer antenna.

3. The system for blocking mobile cellular activity within a transportation vehicle as claimed in claim 1 comprises:
the power supply being electrically connected to the at least one sensor, the processor, the mobile device jamming circuitry, and the jamming antenna.

4. The system for blocking mobile cellular activity within a transportation vehicle as claimed in claim 1, wherein the directional jammer antenna is positioned rearward of a driver seat of the transportation vehicle.

5. The system for blocking mobile cellular activity within a transportation vehicle as claimed in claim 1, wherein the directional jammer antenna is oriented toward a driver seat of the transportation vehicle.

6. The system for blocking mobile cellular activity within a transportation vehicle as claimed in claim 1, wherein the directional jammer antenna broadcasts the short-range cellular jamming radio waves in an obtuse arc oriented toward the front end of the transportation vehicle.

7. The system for blocking mobile cellular activity within a transportation vehicle as claimed in claim 1 comprises:
the at least one sensor comprises a motion sensor, wherein the motion sensor detects whether the transportation vehicle is in motion.

8. The system for blocking mobile cellular activity within a transportation vehicle as claimed in claim 7, wherein the motion sensor is a vehicle speed sensor.

9. The system for blocking mobile cellular activity within a transportation vehicle as claimed in claim 1 comprises:
the at least one sensor comprises a gear position sensor, wherein the gear position sensor detects indicates a current gear position for the transportation vehicle.

10. The system for blocking mobile cellular activity within a transportation vehicle as claimed in claim 1 comprises:
the at least one sensor comprises a driver sensor, wherein the driver sensor detects whether the driver seat of the transportation vehicle is occupied.

11. A method of blocking mobile cellular activity within a transportation vehicle by executing computer-executable instructions stored on a non-transitory computer-readable medium as claimed in claim 1 comprises the steps of:
providing a sensor, wherein the sensor is operatively integrated within a transportation vehicle;
providing mobile device jamming circuitry,
wherein the mobile device jamming circuitry is electrically connected to a directional jammer antenna positioned within an interior of the transportation vehicle;
receiving a signal from the sensor;
processing the signal in order to determine whether the transportation vehicle is in motion or whether the transportation vehicle is capable of motion; and
activating the mobile device jamming circuitry if the signal indicates that the transportation vehicle is in motion or if the signal indicates that the transportation vehicle is capable of motion;
wherein the mobile device jamming circuitry causes the directional jamming antenna to broadcast short-range cellular jamming radio waves if the mobile device jamming circuitry is activated.

12. The method of blocking mobile cellular activity within a transportation vehicle by executing computer-executable instructions stored on a non-transitory computer-readable medium as claimed in claim 11 comprises the steps of:
receiving a gear position signal from the sensor, wherein the sensor is a gear position sensor; and
activating the mobile device jamming circuitry if the gear position signal indicates that the transportation vehicle is in a drive gear.

13. The method of blocking mobile cellular activity within a transportation vehicle by executing computer-executable instructions stored on a non-transitory computer-readable medium as claimed in claim 12 comprises the steps of:
activating the mobile device jamming circuitry if the gear position signal indicates that the transportation vehicle is in neutral.

14. The method of blocking mobile cellular activity within a transportation vehicle by executing computer-executable instructions stored on a non-transitory computer-readable medium as claimed in claim 12 comprises the steps of:
deactivating the mobile device jamming circuitry if the gear position signal indicates that the transportation vehicle is in a parking gear.

15. The method of blocking mobile cellular activity within a transportation vehicle by executing computer-executable instructions stored on a non-transitory computer-readable medium as claimed in claim 11 comprises the steps of:
receiving a parking brake status signal from the sensor, wherein the sensor is a parking brake sensor; and
deactivating the mobile device jamming circuitry if the parking brake status signal indicates that the parking brake is engaged.

16. The method of blocking mobile cellular activity within a transportation vehicle by executing computer-executable instructions stored on a non-transitory computer-readable medium as claimed in claim 11 comprises the steps of:
receiving a motion signal from the sensor, wherein the sensor is a motion sensor; and
activating the mobile device jamming circuitry if the motion signal indicates that the transportation vehicle is in motion.

17. The method of blocking mobile cellular activity within a transportation vehicle by executing computer-executable instructions stored on a non-transitory computer-readable medium as claimed in claim 11 comprises the steps of:
receiving a parking configuration signal from the sensor; and
activating the mobile device jamming circuitry if the gear position signal indicates that the transportation vehicle is not in a parking configuration.
